(19) United States
(12) Patent Application Publication
(10) Pub. No.: US 2003/0003229 A1
(43) Pub. Date: Jan. 2, 2003

(54) Centrifuged rotating drum for treating cohesive powders

(76) Inventor: Otis R. Walton, Livermore, CA (US)

Correspondence Address: INHALE THERAPEUTIC SYSTEMS, INC, 150 INDUSTRIAL ROAD, SAN CARLOS, CA, 94070, US

(21) Appl. No.: 10/170,497

(22) Filed: Jun. 13, 2002

Related U.S. Application Data
(60) Provisional application No. 60/298,238, filed on Jun. 13, 2001.

(51) Int. Cl. B05D 7/00

(52) U.S. Cl. 427/212

(57) ABSTRACT

A method and apparatus are provided for treating a cohesive powder, such as drying, mixing, coating, grinding, or agglomerating the cohesive powder. A drum containing the cohesive powder is rotated. The rotating drum is centrifuged to increase an effective g force acting on the rotating drum.

### RELATED APPLICATIONS

This application claims the benefit of U.S. Provisional Patent Application Serial No. 60/298,238, filed Jun. 13, 2001, the complete disclosure of which is incorporated by reference.

### BACKGROUND OF THE INVENTION

The invention relates generally to the field of powder studies. More particularly, the invention relates to the use of systems for treating powders.

In recent years, there has been increased interest in the use of powders for an extremely wide range of technologies. For example, powders are now used in a variety of fields that include the food and pharmaceutical industries. They are also used as abrasives, pigments, plastics, magnetic coating materials, etc. There is, accordingly, a general need within the field of powder studies for developing methods tailored to treat powders and provide them with specific desirable properties.

Important powder properties include flowability and cohesion. Flowability may affect the transport of powders, such as into molds, through pneumatic systems, and to and from containers. In pharmaceutical applications, where powder medicaments can be delivered through an inhaler device, poor flowability may cause blockages in the powder transport system. The cohesion of the powder directly affects how consistently the powder will behave under similar circumstances. Strongly cohesive powders tend to exhibit chaotic behavior while weakly cohesive powders show more consistency in their behavior.

One technique for affecting the properties of powders uses dry particle coating, in which fine guest particles are coated on a much larger host particle. The principle of dry particle coating is that, within a powder, a layer of ultrafine guest particles may be deposited on the outer surface of relatively larger, but still small, host particles. The layer may be discontinuous, for partial coverage of the host particles, or may be continuous, for complete coverage, and generally acts to change surface properties. For example, the coating of guest particles may lower the cohesive forces acting between host particles to enhance the powder flow behavior. The modified outer surface layer may alternatively be designed to protect the inner host material by changing the chemistry or hardness of the host-particle surface. It may, for example, inhibit particle dissolution or provide other protection to prevent damage to the host particles from chemical, thermal, or mechanical stresses.

Most previously used dry-particle-coating processes, including the Aveka, Theta-composer, Mechanofusion, and Hybridizer processes, subject the powder to severe collisions and/or compressive and shear forces that act to break up agglomerates to achieve intimate contact between the guest and host particles. One such process, described in U.S. Pat. No. 6,197,369, which is herein incorporated by reference for all purposes, attempts to achieve a less-severe environment for dry particle coating. This process uses a centrifuging fluidized bed of cohesive powder mixed with agglomerates of ultrafine guest particles. The use of a fluidizing gas, however, leads to undesirable aerosolization of the fine guest particles. Scavenging of the guest particles from the fluidizing gas flow, such as with a fine filter, adds to the cost of the process. It would therefore be desirable to provide a method for dry particle coating that avoids aerosolization of the guest particles.

It is also often desirable to agglomerate fine cohesive powders to a particular size. Some powders, such as certain submicron-scale powders are usually cohesive and naturally agglomerate together in an irregular manner. When such powders are put into a typical agglomerating rotating drum, they sometimes form large (>1 mm diameter) nearly spherical agglomerates. It would be desirable to provide a method capable of producing much smaller uniformly sized agglomerations, having a diameter on the order of a few microns.

While improvements in each of the areas discussed above are desirable, it would be especially advantageous to provide a single apparatus that simultaneously permits improvements in all of those areas. Such an apparatus would realize cost and efficiency advantages that are not available when the use of multiple apparatuses is required for different applications.

### SUMMARY OF THE INVENTION

Embodiments of the invention thus provide a method and apparatus for treating a cohesive powder, such as drying, mixing, coating, grinding, or agglomerating the cohesive powder. A drum containing the cohesive powder is rotated. The rotating drum is centrifuged to increase an effective g force acting on the rotating drum.

In one embodiment, the centrifugal action is achieved by rotating a centrifugal arm about a first axis. The drum is coupled with the centrifuging arm and configured to rotate about a second axis substantially parallel to the first axis. In certain embodiments, a plurality of such drums is provided. The drum may be configured to roll along the inside surface of a chamber that is configured for rotation about the first axis. Alternatively, the drum and centrifuging arm may be configured for independent rotation. In either case, mechanical linkages may be implemented to drive the assembly with a single drive or with multiple drives.

In some embodiments, the drum further contains a granular guest material composed of guest particles smaller in size than particles of the powder, thereby permitting the powder to be coated with the granular material. A mass ratio between the powder and the granular material may be less than 10%. In other embodiments, the drum contains one or more impact-enhancing particles. In further embodiments, the drum contains a plurality of grinding balls to grind the cohesive powder. In still other embodiments, the drum contains an agglomerating agent to promote agglomeration of the powder. In yet additional embodiments, the drum contains two or more powders to be blended or mixed intimately.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic drawing showing the relationship of angular speeds for a centrifuged rotating drum;

FIG. 2A is a cross-sectional view of an embodiment of a rolling-drum centrifuge illustrating the use of a single driving mechanism;

FIG. 2B is a cross-sectional view of an embodiment of a rolling-drum centrifuge illustrating the use of two driving mechanisms;

FIG. 3A is a cross-sectional view of an embodiment of a geared centrifuged rotating drum illustrating the use of a single driving mechanism;

FIG. 3B is a cross-sectional view of an embodiment of a geared centrifuged rotating drum illustrating the use of two driving mechanisms; and

FIGS. 4A and 4B show the results of simulations for powders in a rolling drum embodiment.

FIGS. 5A, 5B, and 5C are photographs of a cohesive powder, i.e. limestone, in a rolling drum embodiment under different dynamical conditions.

FIGS. 6A, 6B, 6C, and 6D are SEM images of particles treated according to one aspect of the invention.

FIGS. 7A and 7B are SEM images of particle blends according to one aspect of the invention.

FIGS. 8A and 8B are SEM images are coated particles according to one aspect of the invention.

### DETAILED DESCRIPTION OF THE INVENTION

Embodiments of the invention are directed to methods and apparatuses that may be used to treat cohesive powders, such as by allowing dry particle coating, agglomeration, mixing, drying, and/or grinding. Such powder treatment is achieved with a partially filled rotating drum, which may be cylindrical in shape, in a centrifuged arrangement that provides high effective g levels (“g*”) that can overcome the cohesive forces between powder particles. A variety of centrifuged arrangements may be used, some of which are described below for purposes of illustrating aspects of the invention.

For fine cohesive powders (<20 μm, for example), rotating drums at normal g levels often do not achieve the desired break-up of agglomerates or thorough enough mixing on a particle scale because the Earth's gravity acting on the powder does not achieve sufficiently high forces to break the cohesive bonds between the particles. This is especially true for the types of powders used in the pharmaceutical industry. Uniform mixing of fine cohesive powders at normal g levels is particularly difficult to achieve. Operating partially filled rotating drums in a centrifuging environment overcomes several limitations present with normal g levels and broadens the range of processes and particulates that can be processed. For example, as described in detail below, mixing and/or coating can be achieved for fine cohesive powders in a centrifuging environment with an effective g level in the range of 200 g to 2000 g, but the same processes cannot be performed effectively with the same powders in rotating drums at 1 g.

1. Rolling-Drum Centrifuge

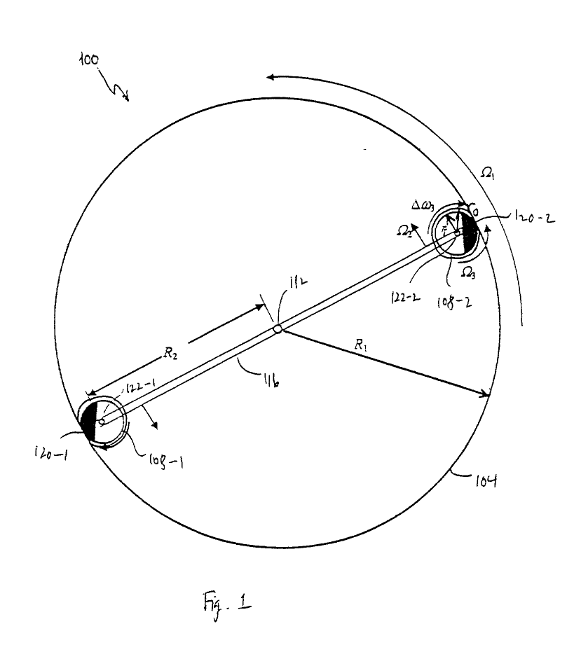

Certain embodiments of the invention use a rolling-drum centrifuge configuration in which a partially filled drum of powder rolls on the inside circumference of a larger rotating container. An example of one such embodiment is shown schematically in FIG. 1. The mechanical principles of the invention are illustrated with this embodiment, although the rolling of the drum and the centrifuged arrangement may be achieved in alternative ways, such as described below.

In this illustrated embodiment, the rolling-drum centrifuge 100 includes two powder drums 108, although it will be evident that it may be configured with an arbitrary number of drums. Each of the powder drums 108 has an inside radius rᵢ and an outside radius rₒ. The outside container 104 is configured as a cylinder with radius R₁, and rotates at an angular speed Ω₁ relative to the fixed Earth frame. The two powder drums 108 are connected with a centrifuging arm 116 adapted to rotate about centrifuge axle 112. The centrifuging arm 116 rotates with angular speed Ω₂ relative to the fixed Earth frame. Each of the powder drums 108 is mounted about a drum axle 122 connected with the centrifuging arm at a radius R₂ from the centrifuge axle 112. Mounting of the drum axle 122 so that it is connected with the centrifuging arm 116 allows for slight movement in the radial direction to account for strain as the centrifugal acceleration varies. In an alternative embodiment, the powder drums 108 are supported by exterior rollers instead of an axle.

Since the rotation rate Ω₁ of the outside container 104 is controlled independently of the rotation rate Ω₂ of the centrifuging arm 116, the powder drums 108 roll around the inner circumference of the outside container 104 at angular speed Ω₃ relative to the fixed Earth frame. This angular speed may be expressed as a relative rolling angular speed Δω₃ with respect to a frame rotating with the centrifuging arm 116 at angular speed Ω₂. When the rotation speeds of the outer container 104 and the centrifuging arm 116 are nearly equal, Ω₁≅Ω₂, the powder drums 108 roll slowly around the circumference.

FIG. 1 includes several arrows indicating the direction of motion of components of the rolling-drum centrifuge 100 in a particular embodiment of the invention where Ω₂>Ω₁>0 and Ω₃<Ω₂, so that Δω₃>0. A closed-form expression for Δω₃ may be derived in terms of the absolute angular speeds Ω₁ and Ω₂ by imposing the slip-free rolling condition. Thus, the radius of the outside container 104 is equal to the sum of the radial position of the drum axle 122 and the radius of the drum axis 108,

R₁=R₂+r,

and the slip-free rolling condition equates the linear speeds of the powder drum 108 at the point of contact with the outside container 104 to the circumferential speed of the outside container 104,

R₂Ω₂+r₀Ω₃=R₁Ω₁.

Using these results, the effective rolling rate of the powder drum 108 is determined from the difference in absolute angular speeds of the centrifuging arm 116 and the powder drum 108:

Δω₃=Ω₂−Ω₃=[1+(R₂/r₀)]Ω₂−(R₁/r₀)Ω₁.

Some approximate dimensional and speed values illustrate the operation of the centrifugal rotating drum. For example, for the centrifugal acceleration from the relative rolling of the powder drum 108 to be two orders of magnitude less than that of the principal centrifuging acceleration, i.e. Δω₃²rᵢ≦0.01 Ω₂²R₂, then

Δω₃^{/}Ω₂≦0.01(R₂/rᵢ)^{1/2}

Thus, if R₂≅10 cm, r₀≅1 cm, and rᵢ≅0.5 cm, the ratio Δω₃/Ω₂ is approximately 0.71, which is achieved by setting Ω₁ about 6.5% slower or faster than Ω₂. For centrifuging accelerations in the range of 1000 g, the angular speeds, Ω₂, would be on the order of 3000 revolutions per minute.

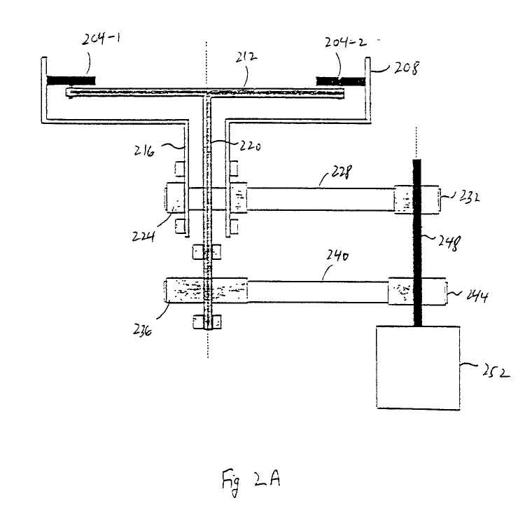

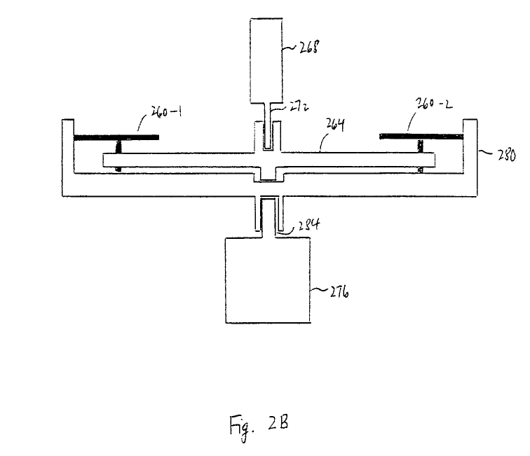

An example of a drive arrangement that may be used to configure the embodiment that uses a rolling-drum centrifuge is shown in FIG. 2A. Powder drums 204 are engaged with beam 212, which acts as the centrifuging arm. The outside container is provided as a frame 208 configured to be continuous with a sleeve 216 that surrounds a portion of a spindle 220 that acts as the centrifuge axle. Belt drives are provided for rotation of the sleeve 216 and of the spindle 220. The first belt drive includes belt 228 configured as an endless loop engaged with pulleys 224 and 232. Pulley 224 is fixedly coupled with the sleeve 216 so that motion of belt 228 results in rotational motion of the frame 208 at angular speed Ω₁. The second belt drive includes belt 240 configured as an endless loop engaged with pulleys 236 and 244. Pulley 236 is fixedly coupled with the spindle 220 so that motion of belt 240 results in rotational motion of the spindle 220 at angular speed Ω₂. Pulleys 232 and 244 are coupled with a common shaft 248, which is driven by motor 252. Angular speeds Ω₁ and Ω₂ are determined not only by the rotation speed of shaft 248, but also by the relative sizes of pulleys 224, 232, 236, and 244 so that Ω₁ and Ω₂ may be defined independently. In an alternative embodiment, the drums 204 are supported by exterior rollers instead of an axle.

A second example of a drive arrangement that may be used to configure the rolling-drum centrifuge is shown in FIG. 2B. Powder drums 260 are engaged with beam 264, which acts as the centrifuging arm. The beam 264 is configured for engagement with the shaft 272 of a first motor 268 such that rotation of the shaft 272 by the first motor 268 causes rotation of the beam 264 at angular speed Ω₂. The outside container is provided as a frame 280 that is configured for engagement with the shaft 284 of a second motor 276 such that rotation of the shaft 284 by the second motor 276 causes rotation of the frame 280 at angular speed Ω₂. This arrangement thus uses two motors but avoids the use of the belt-drive pulley assemblies. In an alternative embodiment, the drums 260 are supported by exterior rollers instead of an axle.

2. Geared Centrifuged Rotating Drum

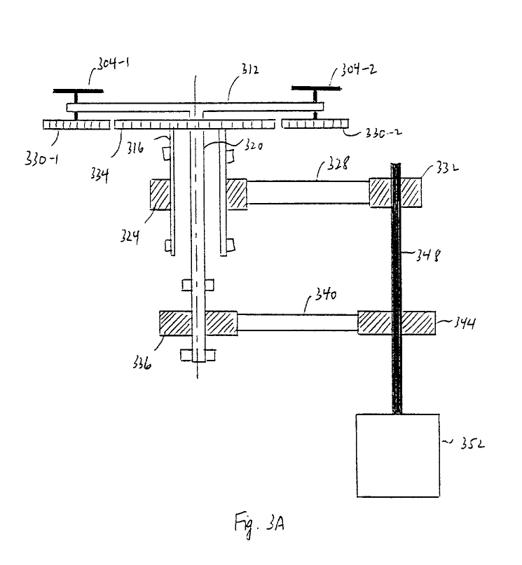

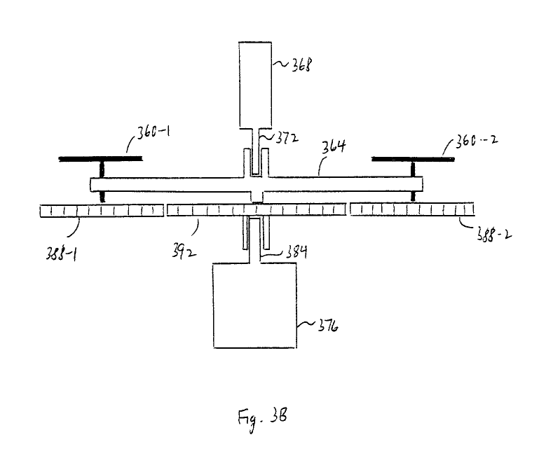

Alternative embodiments that use a geared system, rather than a rolling-drum system, are illustrated in FIGS. 3A and 3B. These embodiments may achieve the same dynamical properties as the rolling-drum configurations. In particular, the powder-containing drums rotate to treat the powder, but are subjected to centrifugal forces that cause high effective g levels to overcome cohesive forces between the powder particles.

One embodiment that uses a single driving mechanism is shown in FIG. 3A. Powder drums 304 are engaged with beam 312, which acts as the centrifuging arm. The powder drums 304 are connected with gears 330 and the beam 312 is connected with gear 334, which is engaged with gears 330. The powder drums 304 are rotated with this gear arrangement by a first belt that includes belt 328 configured as an endless loop engaged with pulleys 324 and 323. Pulley 324 is fixedly coupled with a sleeve 316 that is in turn coupled with gear 334. Accordingly motion of belt 328 results in rotation of sleeve 316 and gear 334, which transfers rotational motion to the powder drums 304 through gears 330. A second belt drive is configured to rotate the beam 312, which is continuous with a spindle 320 that acts as the centrifuge axle. The second belt drive includes belt 340 configured as an endless loop engaged with pulleys 336 and 344. Pulley 336 is fixedly coupled with spindle 320 so that motion of belt 340 results in rotational motion of the spindle 320. Pulleys 332 and 344 are coupled with a common shaft 348, which is driven by motor 352. Angular speeds Ω₁ and Ω₂ are determined not only by the rotation of shaft 348, but also by the relative sizes of pulleys 324, 332, 336, and 344 and by the gear ratios between gear 334 and gears 330, so that Ω₁ and Ω₂ may be defined independently.

A second example of a geared drive arrangement that uses two drives is shown in cross-section view in FIG. 3B. Powder drums 360 are engaged with beam 364, which acts as the centrifuging arm. The beam 364 is configured for engagement with the shaft 372 of a first motor 368 such that rotation of the shaft 372 by the first motor 368 causes rotation of the beam 364. The powder drums 360 are connected with gears 388, which are in turn coupled with gear 392. Gear 392 is configured for engagement with the shaft 384 of a second motor 376 so that rotation of the shaft 384 transmits rotational motion to the powder drums 360 through the gear arrangement.

3. Exemplary Applications

Irrespective of how the centrifuged rotating drum is configured, the combined features of drum rotation with large effective g values may be exploited in embodiments of the invention to treat cohesive powders in a variety of ways. Such treatment may include drying, mixing, coating, agglomerating and/or grinding, among others.

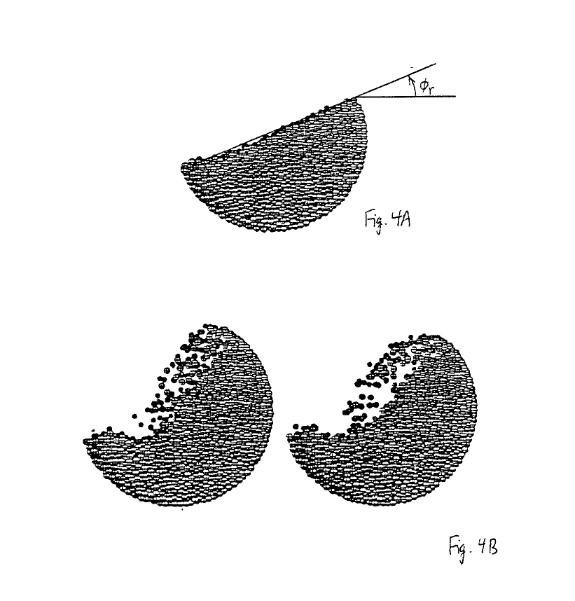

FIGS. 4A and 4B show simulation results that illustrate generally the behavior of a granular material such as a powder within the rotating-drum centrifuge. The figures exemplify the behavior of the powder for different rotation speeds Δω₃. At slow rotation speeds, such as shown in FIG. 4A, the flow has a well-defined angle of repose φᵣ. At low rolling rates, periodic avalanches may occur. As drum rotation speed Δω₃ increases, inertial effects of the powder being carried beyond the equilibrium height at the top of the incline cause an increase in the dynamic angle of repose φᵣ. The increase in Δω₃ also causes a change in character of the top surface from nearly linear to an approximate S shape having a steeper slope in the upper half and a flatter slope in the lower half. At still faster rotation speeds, such as shown in FIG. 4B, the cascading flow becomes a continuous gentle flow of a cresting wavelike ballistic trajectory for the particles as the angle of repose is exceeded. The operating flexibility provided by the independent rotation rate control allows the cascading flow to vary in energy intensity, from a flow as gentle as that of a centrifuging fluidized bed, to as intense as a grinding ball mill operating at high effective g values.

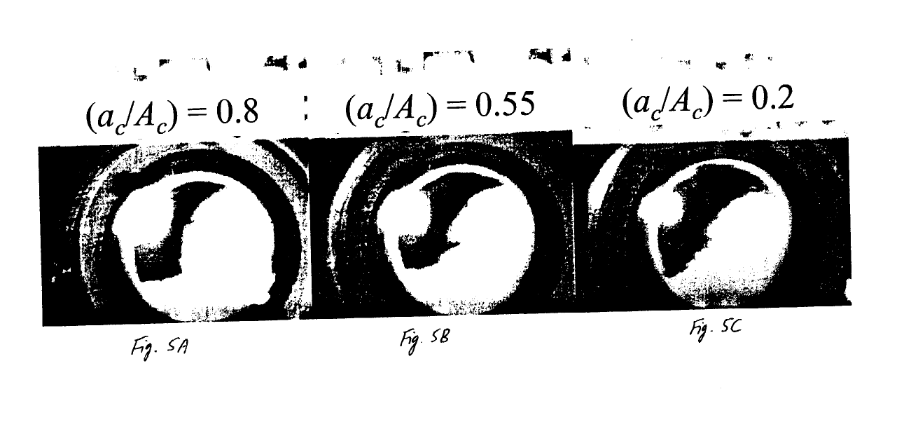

The main centrifuging acceleration, A_{c}, and the centrifugal acceleration, a_{c}, due to rotation of the powder-containing drum can be varied to achieve various ballistic, cascading powder beds useful for particle coating. Images of powder flow at the same g level of 330 g but with different rotation rates are depicted in FIGS. 5A-5C, respectively. For FIGS. 5A, 5B, and 5C, the centrifugal acceleration due to rotation of the powder-containing drum is 0.8, 0.55, and 0.2 times the main centrifuging acceleration. The operating flexibility provided by the independent rotation rate control allows the cascading flow to vary in energy intensity, from a flow as gentle as that of a centrifuging fluidized bed, to as intense as a grinding ball mill operating at high effective g values.

a. Dry Particle Coating

Embodiments of the invention may thus be used for improved methods of dry particle coating since the flexibility of the centrifuged rotating drum makes it possible to achieve a gentle processing environment without the use of a fluidizing gas. In particular, as discussed above, the physical operation of the rolling-drum centrifuge may be adjusted to achieve a wide variety of flow behaviors. The powder drum 108 is partially filled with a cohesive powder that comprises the host particles and with a quantity of material that comprises the guest particles (or additive particles), which may be of approximately submicron size. In some embodiments, the mass ratio between the host powder and the guest material is less than 10%. In one embodiment, this mass ratio is less than 1%.

The rolling-drum centrifuge is operated within a region of its operating characteristics that acts to mix the materials continuously, thereby bringing the host and guest materials into contact to effect the dry particle coating of the host powder. Such characteristics may be achieved by choosing dimensions (rₒ, rᵢ, R₁, and R₂) and rotation speeds (Ω₁ and Ω₂) so that the centrifugal acceleration due to rotation of the powder drum 108 is less than twice the centrifuging acceleration of the centrifuging arm 116. The centrifuging acceleration of the centrifuging arm 116 is usually greater than 10 g, but for some free-flowing powders may be as small as 40 g. Under such conditions, sufficient forces are provided to break up the cohesive host powder and to create collisions between the host and guest particles required to achieve dry particle coating. Furthermore, the operating conditions may be adjusted to maximize the effectiveness of the coating according to a number of properties of the host powder and the guest material, such as the relative sizes of the host and guest particles and the cohesiveness of the host powder and guest material. The method thus not only avoids the need for a fluidizing gas flow, but permits increased operational flexibility.

The host powder preferably comprises a pharmaceutically active agent, with or without additional excipients. The host powder may be prepared by methods known in the art such as micronization, solvent evaporation, supercritical fluid processing, or spray drying. Suitable pharmaceutically active agents, excipients, and processes for the preparation are disclosed, for example, in U.S. Pat. Nos. 5,851,453, 6,063,138, 6,051,256, and in WO 96/32149, WO 01/00312, and WO 02/09669, all of which are hereby incorporated in their entirety by reference. Alternatively, the host particle may comprise an excipient or flow-aid.

The guest material preferably comprises an excipient or flow aid such as an amino acid such as leucine, tri-leucine, isoleucine, lysine, valine, methionine, phenylalanine, a metal stearate such as magnesium stearate, calcium stearate, or sodium stearate, or a surface active material such as phospholipids or fatty acids such as oleic acid, lauric acid, and stearic acid. Such excipient and flow-aids are disclosed in, for example, WO 96/32149 set forth above, and in WO 97/23485 and WO 02/00197, hereby incorporated in their entirety by reference. It is possible that the guest material comprises a pharmaceutically active agent.

In some embodiments, a small number of relatively large particles are included in the flowing material to enhance impacts. In one embodiment, such impact-enhancing particles may comprise ceramic spheres. With such particles, the impacts may mimic the intensity of those provided by magnetically assisted impact processes, but avoid the need for an externally applied oscillatory magnetic field.

This general method may be adapted to a number of different processing modes. In one embodiment, the method is used as part of a batch process in which the powder drums 108 are completely closed during dry particle coating and may be operated at elevated or reduced air pressure, or with a controlled humidity. They may be filled with any desired gas to enhance or prevent chemical reactions during the mechanical processing. In an alternative embodiment, the powder drums are open to ambient pressure and used as part of a continuous process in which host powder and guest materially are flowed into one end of a drum 108 and coated powder is flowed out the other end.

b. Agglomeration

The rolling-drum centrifuge may also be used to agglomerate fine cohesive powders to a particular size, including sizes on the order of a few microns. For such applications, the rolling-drum centrifuge is operated with a powder-drum angular speed Δω₃ so that an approximately linear, continuously flowing dynamic angle of repose is achieved. The dimensional (rₒ, rᵢ, R₁, and R₂) and rotation-speed parameters (Ω₁ and Ω₂) used to produce such a flow depend on the specific characteristics of the powder to be agglomerated, including particle size and cohesion. An appropriate flow is generally achieved with a ratio of centrifugal accelerations Δω₃²rᵢ≦0.05Ω₁²R₁. In one embodiment, this ratio is in the range of 0.0001 to 0.02.

The method may be modified in a number of different ways if the particles are insufficiently cohesive to create the desired agglomeration. For example, in one embodiment, the operating environment is specifically configured to promote agglomeration. This may be achieved, for example, by increasing the humidity to result in a temporary increase in the magnitude of the cohesive forces acting between the particles. In another embodiment, an agglomerating agent is added to the powder to promote agglomeration despite the relatively weak cohesive forces. Appropriate agglomerating agents will depend on the particular powder compositions used and will be known to those of skill in the art. Typical agglomerating agents include polyvinylpyrrolidone, poly (oxyethylene), polyethyleneglycol, carbowax, nonionic surfactants, fatty acids, sodium carboxymethyl cellulose, gelatin, fatty alcohols, phosphates and polyphosphates, clays, aluminosilicates and polymeric polycarboxylates.

c. Grinding/Milling

In still other embodiments, the powder in the powder drum may be ground to a finer state by including a number of relatively larger, hard, grinding balls inside the powder drum. When the powder drum is rotated sufficiently fast to cause ballistic or arcing flow with high energy impacts near the toe of the flow, the powder is effectively ground. With the larger effective g values provided by the centrifuged mechanism, it is possible to grind the powder to a finer state than would be possible with normal g values.

d. Blending

In yet further embodiments, two or more powders are placed in the powder drum and the powder drum is rotated while being centrifuged to achieve intimate mixing on a particle scale. According to this embodiment, a blend of two or more drugs can be obtained, or an excipient or flow aid can be blended with at least one additional drug. Suitable drugs and excipients are disclosed in the patents and patent applications set forth above.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

### EXAMPLE 1

Various spray-dried powder samples were placed inside a ⅜″ diameter sample cell of an apparatus described above with respect to FIG. 2B. The powder compositions and treatment are set forth in Table 1.

TABLE 1
Powder Processing

| | | Processing | Processing |
|---|---|---|---|
| Sample | Formulation | condition | time |
| 1 | Sucrose | 900 g | 3 min |
| 2 | Sucrose | No treatment | |
| 3 | Leucine | No treatment | |
| 4 | Leucine | 900 g | 3 min |

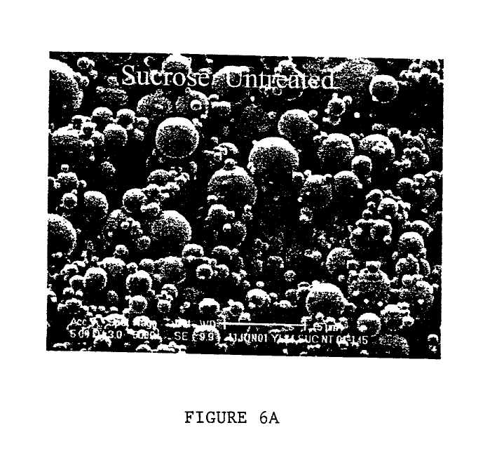

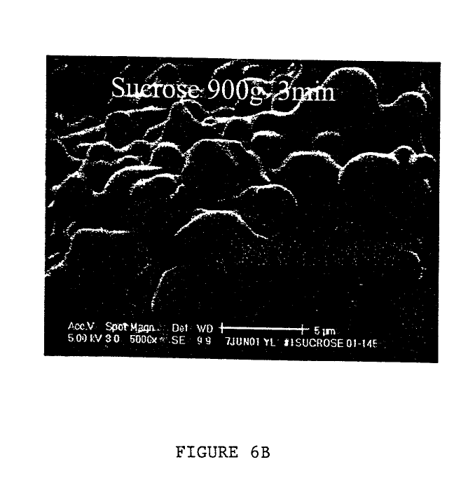

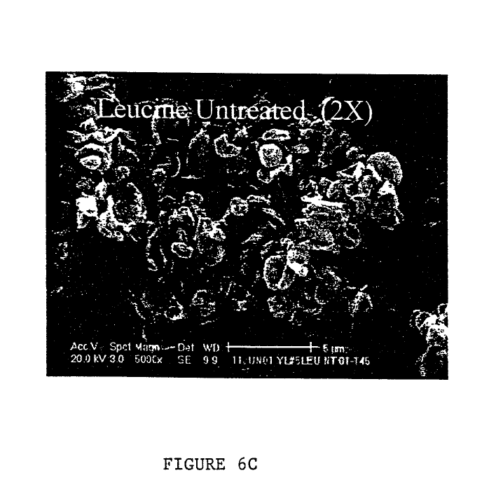

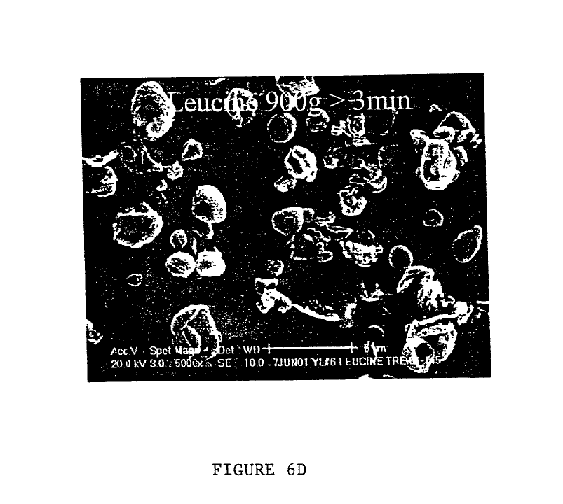

SEM images of the samples were then taken after processing and are depicted in FIGS. 6A-D, corresponding to Samples 1-4, respectively. FIGS. 6A and 6B show that sucrose particles appeared to melt or fuse together after processing, while FIGS. 6C and 6D show that the processing successfully disrupted agglomerates of the untreated leucine sample, thus demonstrating the applicability of the process as an autogenous grinding method.

### EXAMPLE 2

Mixtures of spray-dried sucrose and leucine at a mass ratio of 10:1 (33 mg sucrose, 3.1 mg leucine) were placed inside a ⅜″ diameter sample cell and treated using the apparatus described above with respect to FIG. 2B as shown in Table 2.

TABLE 2
Powder Blending

| | | Processing | Processing |
|---|---|---|---|
| Sample | Formulation | condition | time |
| 1 | Sucrose/Leucine | Hand mixed | 5 min |
| | (10/1% w/w) | | |
| 2 | Sucrose/Leucine | 900 g | 3 min |
| | (10/1% w/w) | 400 g | 2 min |

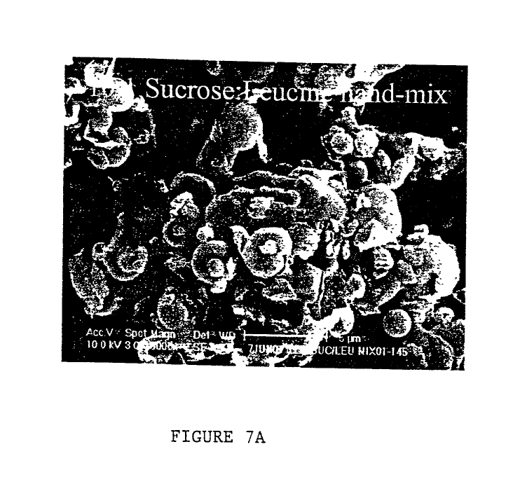

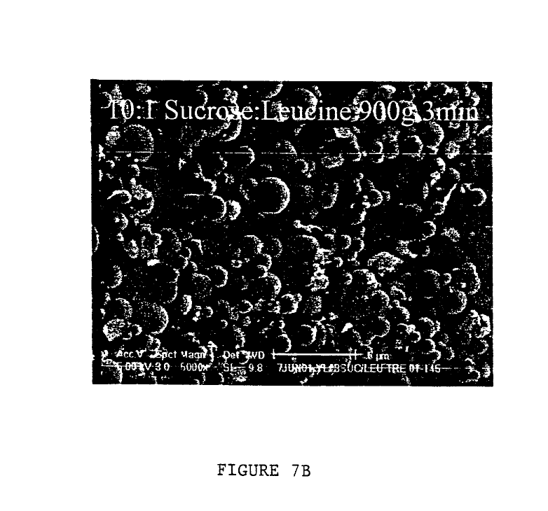

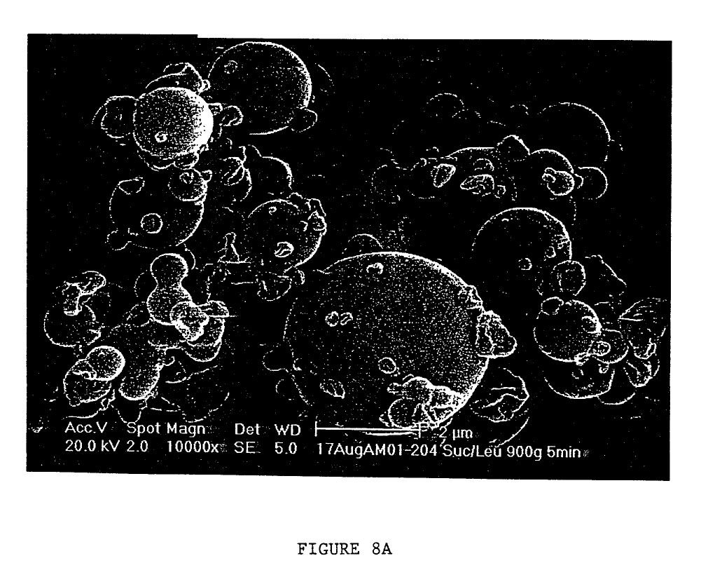

SEM images of the samples were then taken after processing and are depicted in FIGS. 7A-B, corresponding to Samples 1 and 2, respectively. FIGS. 7A and 7B depict blends of the host (sucrose) and guest (leucine) particles, with the blend prepared with treatment according to the present invention consisting of fewer agglomerated particles.

### EXAMPLE 3

Samples of sucrose, leucine or tri-leucine were spray dried separately and combined in a ⅜″ sample cell of the apparatus described above with respect to FIG. 2B for processing. The samples and processing conditions are set forth in Table 3.

TABLE 3

| | Formulation | Processing | Processing |
|---|---|---|---|
| Sample | (w/w) | condition | time |
| 1 | Sucrose/leucine | 900 g | 3 min |
| | 90/10 | | |
| 2 | Sucrose/tri- | 900 g | 3 min |
| | leucine | | |
| | 95/5 | | |

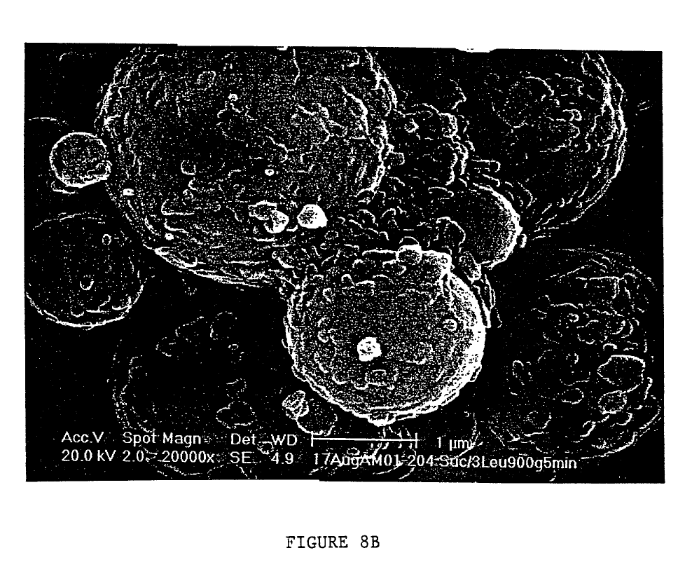

The processed powders were analyzed by SEM. FIGS. 8A and 8B depict the processed powders of Samples 1 and 2, respectively. As seen in FIGS. 8A and 8B, the leucine and tri-leucine provided a discontinuous coating on the surface of the sucrose particles. The sucrose host particles had a particle size of greater than 1 micron, while the leucine or tri-leucine guest particles had a particle size less than 1 micron.

It is claimed:

1. A method for treating a powder, the method comprising:
rotating a drum containing the powder;
centrifuging the rotating drum to increase an effective g force acting on the rotating drum.

2. The method recited in claim 1 wherein the drum is connected with a centrifuging arm and wherein centrifuging the rotating drum comprises rotating the centrifuging arm.

3. The method recited in claim 2 wherein rotating the drum comprises rolling the drum along an inside surface of the chamber.

4. The method recited in claim 2 wherein the drum and centrifuging arm are rotated independently.

5. The method recited in claim 1 wherein the drum further contains a granular guest material composed of guest particles smaller in size than particles of the powder, to coat the powder with the granular guest material.

6. The method recited in claim 5 wherein a mass ratio between the powder and the granular guest material is less than 10%.

7. The method recited in claim 5 wherein a mass ratio between the powder and the granular guest material is less than 1%.

8. The method recited in claim 1 wherein a centrifugal acceleration due to rotation of the drum is less than twice a centrifuging acceleration due to rotation of the centrifuging arm.

9. The method recited in claim 1 wherein the drum further contains an impact-enhancing particle.

10. The method recited in claim 1 wherein the drum further contains a plurality of grinding balls to grind the cohesive powder.

11. The method recited in claim 1 wherein the drum rotates at a rate to produce an approximately linear dynamic angle of repose for the powder, to agglomerate the powder.

12. The method recited in claim 11 wherein a centrifugal acceleration at a rotation axis of the drum is less than 0.05 times a centrifugal acceleration at an edge of the drum.

13. The method recited in claim 11 wherein a centrifugal acceleration at a rotation axis of the drum is between 0.0001 and 0.02 times a centrifugal acceleration at an edge of the drum.

14. The method recited in claim 11 wherein the drum further contains an agglomerating agent.

15. The method recited in claim 1 wherein treating the powder comprises blending the powder.

16. The method recited in claim 1 wherein treating the powder comprises drying the powder.

17. The method recited in claim 1 wherein t he powder ha s an average particulate size less than about 20 μm.

18. An apparatus for treating a cohesive powder, the apparatus comprising:
a centrifuging arm configured for rotation about a first axis; and
a drum adapted to hold the cohesive powder, wherein the drum is coupled with the centrifuging arm and configured to rotate about a second axis substantially parallel to the first axis.

19. The apparatus recited in claim 18 further comprising a chamber configured for rotation about the first axis and positioned for the drum to roll along an inside surface of the chamber.

20. The apparatus recited in claim 19 wherein the chamber is coupled with a first drive adapted to rotate the chamber about the first axis at a first angular speed and wherein the centrifuging arm is coupled with a second drive adapted to rotate the centrifuging arm about the first axis at a second angular speed.

21. The apparatus recited in claim 19 further comprising:
a first pulley assembly adapted to rotate the chamber, the first pulley assembly including a first end coupled with the chamber and a second end coupled with a shaft; and
a second pulley assembly adapted to rotate the centrifuging arm, the second pulley assembly including a first end coupled with the centrifuging arm and a second end coupled with the shaft.

22. The apparatus recited in claim 21 further comprising a drive adapted to rotate the shaft.

23. The apparatus recited in claim 18 wherein the centrifuging arm is coupled with a first drive adapted to rotate the centrifuging arm about the first axis at a first angular speed and wherein the drum is geared with a second drive adapted to rotate the drum about the second axis.

24. The apparatus recited in claim 18 further comprising:
a first pulley assembly adapted to rotate the centrifuging arm about the first axis, the first pulley assembly including a first end coupled with the centrifuging arm and a second end coupled with a shaft; and
a second pulley assembly adapted to rotate the drum about the second axis, the second pulley assembly including a first end gear coupled with the drum and a second end coupled with the shaft.

25. The apparatus recited in claim 18 further comprising a second drum adapted to hold the powder, wherein the second drum is coupled with the centrifuging arm and configured to rotate about a third axis substantially parallel to the first axis.

26. A method for making composite particles comprising milling particles of a pharmaceutically active agent having a mass median diameter of less than 30 microns in the presence of an additive material having a mass median diameter less than that of the particles containing the pharmaceutically active agent.
